(19) United States
(12) Patent Application Publication
(10) Pub. No.: US 2025/0249728 A1
(43) Pub. Date: Aug. 7, 2025

(54) THERMAL CONDITIONING SYSTEM

(71) Applicant: VALEO SYSTEMES THERMIQUES, La Verriere (FR)

(72) Inventors: Roland AKIKI, La Verriere (FR); Bertrand NICOLAS, La Verriere (FR); Rody EL-CHAMMAS, La Verriere (FR); Muriel PORTO, La Verriere (FR)

(73) Assignee: VALEO SYSTEMES THERMIQUES, La Verriere (FR)

(21) Appl. No.: 18/856,710

(22) PCT Filed: Apr. 6, 2023
(86) PCT No.: PCT/EP2023/059246

§ 371 Date: Oct. 14, 2024

(30) Foreign Application Priority Data
Apr. 13, 2022 (FR) FR2203420

(51) Int. Cl. B60H 1/00; B60H 1/32

(52) U.S. Cl. CPC B60H 1/00921; B60H 1/3229; B60H 1/323

(57) ABSTRACT

The invention relates to a thermal conditioning system for a motor vehicle, having: a main refrigerant fluid circulation loop including successively: a compressor, a first heat exchanger, a refrigerant fluid accumulation device, a second heat exchanger, a first bypass branch connecting a first connection point to a second connection point, a second bypass branch connecting a third connection point to a fourth connection point, a third bypass branch connecting a fifth connection point to a sixth connection point, the main loop having: a first expansion valve disposed between the first connection point and the accumulation device, a second expansion valve disposed between the fifth connection point and the second exchanger, and the third bypass branch having a third expansion valve and a third heat exchanger.

### TECHNICAL FIELD

The present invention relates to e field of thermal conditioning systems. Such systems may, for example, equip motor vehicles. These systems make it possible to thermally regulate various members, such as for example the passenger compartment or an electrical energy storage battery, in the case of an electrically powered vehicle. The heat exchanges are mainly managed by the compression and expansion of a refrigerant fluid circulating in a circuit in which a plurality of heat exchangers are disposed. A compressor makes it possible to bring the refrigerant fluid to high pressure and to circulate it in the circuit.

### BACKGROUND OF THE INVENTION

The refrigerant fluid circuit usually has a main loop and a plurality of bypass branches that make it possible to realize multiple combinations of circulation of the refrigerant fluid. Numerous modes of operation can thus be obtained, for example the cooling of the air in the passenger compartment, the heating of the air in the passenger compartment, the dehumidification of the air in the passenger compartment, or else the cooling of the batteries of the vehicle. It is well known to dispose, downstream of the compressor, a heat exchange or that can operate as a condenser, i.e. that can condense the refrigerant fluid at high pressure and high temperature at the outlet of the compressor.

It is also known to install, downstream of this condenser, an exchanger that makes it possible to subcool the refrigerant fluid, in order to improve the thermodynamic performance of the thermal conditioning system. However, the addition of such an exchanger may be awkward or even impossible.

There is therefore a need to have systems with improved performance in all the modes of operation without requiring a subcooling exchanger.

### SUMMARY OF THE INVENTION

To this end, the present invention proposes a thermal conditioning system for a motor vehicle, having a refrigerant fluid circuit configured to circulate a refrigerant fluid, the refrigerant fluid circuit having:
a main loop comprising, successively in the direction of circulation of the refrigerant fluid:
a compressor,
a first heat exchanger configured to exchange heat with a first heat transfer fluid,
a refrigerant fluid accumulation device,
a second heat exchanger configured to exchange heat with an air stream outside a passenger compartment of the vehicle,
a first bypass branch connecting a first connection point disposed on the main loop between the first exchanger and the refrigerant fluid accumulation device to a second connection point disposed on the main loop between the second exchanger and an inlet of the compressor,
a second bypass branch connecting a third connection point disposed on the main loop between the first connection point and the refrigerant fluid accumulation device to a fourth connection point disposed on the main loop between the refrigerant fluid accumulation device and the second heat exchanger,
a third bypass branch connecting a fifth connection point disposed on the main loop between the refrigerant fluid accumulation device and the fourth connection point to a sixth connection point disposed on the main loop between the second connection point and the inlet of the compressor,
wherein the main loop comprises:
a first expansion device disposed between the first connection point and an inlet of the refrigerant fluid accumulation device,
a second expansion device disposed between the fifth connection point and the second heat exchanger,
and wherein the third bypass branch has a third expansion device and a third heat exchanger configured to operate as an evaporator.

This configuration makes it possible to realize a first level of expansion of the refrigerant fluid between the outlet of the first heat exchanger and the inlet of the accumulation device. The refrigerant fluid having undergone the partial expansion thus has a enthalpy that is lower than at the outlet of the first heat exchanger. The performance of the thermal conditioning system is thus improved compared with operation without partial expansion.

The features listed in the following paragraphs can be implemented independently of one another or in any technically possible combination:

According to one embodiment of the thermal conditioning system, the first beat transfer fluid is an air stream inside a passenger compartment of a motor vehicle.

According to a variant embodiment of the thermal conditioning system, the first heat transfer fluid is a heat transfer liquid. The thermal conditioning system has a heat transfer liquid circuit configured to circulate a heat transfer liquid. The first heat exchanger is a two-fluid heat exchanger arranged jointly on the refrigerant fluid circuit and on the heat transfer fluid circuit so as to allow beat exchange between the refrigerant fluid and the heat transfer liquid.

The third heat exchanger is for example configured to exchange heat with an air stream inside the passenger compartment of the vehicle.

The refrigerant fluid accumulation device is a bottle of desiccant.

According to a first embodiment of the thermal conditioning system, the first expansion device is disposed on the main loop between the first connection point and the third connection point, and
the second expansion device is disposed on the main loop between the fifth connection point and the fourth connection point.

The first expansion device is a calibrated orifice. The second expansion device is an electronic expansion valve.

The second bypass branch comprises a fourth expansion device.

The fourth expansion device is a calibrated orifice.

The use of calibrated orifices makes it possible to realize the first level of expansion, between the first heat exchanger and the bottle of desiccant, through an inexpensive component.

According to a second embodiment of the thermal conditioning system, the first expansion device is disposed on the main loop between the first connection point and the third connection point, and
the second expansion device is disposed on the main loop between the fourth connection point and the second heat exchanger.

The first expansion device is a calibrated orifice. The second expansion device is an electronic expansion valve.

According to a third embodiment of the thermal conditioning system, the first expansion device is disposed on the main loop between the third connection point and an inlet of the refrigerant fluid accumulation device, and
the second expansion device is disposed on the main loop between the fifth connection point and the fourth connection point.

The first expansion device is an electronic expansion valve. The second expansion device is an electronic expansion valve.

The use of electronic expansion valves makes it possible to adapt, in real time, the amplitude of the first level of expansion to all the conditions encountered.

According to a fourth embodiment of the thermal conditioning system, the first expansion device is disposed on the main loop between the first connection point and the third connection point, and
the second expansion device is disposed on the main loop between the fourth connection point and the second heat exchanger.

The first expansion device is an electron c expansion valve. The second expansion device is an electronic expansion valve.

According to one aspect of the thermal conditioning system, the second bypass branch comprises a first non-return valve configured to block circulation of refrigerant fluid from the third connection point to the fourth connection point.

The first non-return valve makes it possible to prevent the refrigerant fluid at high pressure at the inlet of the accumulation device from flowing back to the fourth connection point by circulating in the second bypass branch.

According to one implementation example, the main loop comprises a second non-return valve configured to block circulation of refrigerant fluid from the sixth connection point to the second connection point.

According to one embodiment, the main loop comprises a third non-return valve configured to block circulation of refrigerant fluid from the fourth connection point to the fifth connection point.

According to one implementation example, the third bypass branch comprises a fourth non-return valve configured to block circulation of refrigerant fluid from the eighth connection point to the third heat exchanger.

The main loop comprises a shut-off valve disposed between the second connection point and the sixth connection point.

According to a variant embodiment of the thermal conditioning system, the main loop comprises a first internal heat exchanger configured to allow heat exchange between the refrigerant fluid downstream of the first expansion device and the refrigerant fluid downstream of the second heat exchanger.

The first internal heat exchanger makes it possible to superheat the refrigerant fluid at the inlet of the compressor, i.e. makes it possible to avoid the presence of droplets of liquid refrigerant at the inlet of the compressor.

According to a variant, the third bypass branch comprises a second internal heat exchanger configured to allow heat exchange between the refrigerant fluid upstream of the third expansion device and the refrigerant fluid downstream of the third heat exchanger.

The second internal heat exchanger makes it possible to increase the variation in enthalpy between the inlet and the outlet of the third heat exchanger. The cooling performance is improved.

According to a variant embodiment, the thermal conditioning system has a fourth bypass branch in parallel with the third expansion device and the third heat exchanger, the fourth bypass branch having a fifth expansion device and a fourth heat exchanger.

The fourth bypass branch connects a seventh connection point disposed on the third bypass branch between the fifth connection point and the third expansion device to an eighth connection point disposed on the third bypass branch between the third heat exchanger and the sixth connection point.

According to one exemplary embodiment, the fourth heat exchanger is thermally coupled to an element of a drive train of a motor vehicle.

The fourth heat exchanger thus makes it possible to control the operating temperature of the element of the drive train of the vehicle.

The element of the electric drive train of the vehicle may comprise an electrical energy storage battery.

The battery may supply the energy necessary to drive the vehicle.

The element of the electric drive train of the vehicle may comprise an electric drive motor of the vehicle.

The element of the electric drive train of the vehicle may comprise an electronic control unit for the electric drive motor of the vehicle.

The fourth heat exchanger is thermally coupled to the element via a heat transfer liquid circulating in a secondary heat transfer liquid loop.

The heat transfer liquid circulating in the secondary heat transfer liquid loop may be a dielectric fluid.

According to a variant embodiment, the fourth heat exchanger is in contact with the element of the drive train of the vehicle.

The heat exchange liquid circuit may have a fifth heat exchanger configured to exchange heat with a flow of air inside a passenger compartment of the vehicle.

The thermal conditioning system may have a three-way valve disposed jointly on the main loop and the first bypass branch, the three-way valve being configured to selectively:
allow circulation of the refrigerant fluid at the outlet of the first exchanger to the third connection point and prevent circulation of the refrigerant fluid at the outlet of the first exchanger to the second connection point, or
allow circulation of the refrigerant fluid at the outlet of the first exchanger to the second connection point and prevent circulation of the refrigerant fluid at the outlet of the first exchanger to the third connection point.

According to one implementation example, the three-way valve and the first expansion device form a one-piece assembly.

The integration into the thermal conditioning system is thus made easier.

The invention also relates to a method of operation of a thermal conditioning system as described above, in a mode referred to as heating mode, wherein:
a flow of refrigerant fluid at low pressure circulates in the compressor where it is brought to high pressure, and then circulates successively in the first heat exchanger, giving up heat to the first heat transfer fluid, in the first expansion e where it undergoes expansion to an intermediate pressure, in the second heat exchanger, in the refrigerant fluid accumulation device, in the second expansion device where it is brought to low pressure, in the second heat exchanger where it evaporates, absorbing heat from the outside air stream, and returns to the compressor.

The invention also relates to a method of operation of a thermal conditioning system as described above, in a mode referred to as cooling mode, wherein:
a flow of refrigerant fluid at low pressure circulates in the compressor where it is brought to high pressure, and then circulates successively in the first heat exchanger, giving up heat to the first heat transfer fluid, in the first bypass branch, in the second heat exchanger, in the second expansion device where it undergoes expansion to an intermediate pressure, in the second bypass branch, in the refrigerant fluid accumulation device, in the third bypass branch, in the third expansion device where it is brought to low pressure, in the third heat exchanger where it evaporates, absorbing heat, and returns to the compressor.

The invention also relates to a method of operation of a thermal conditioning system according to another embodiment, in a mode referred to as cooling mode, wherein:
a flow of refrigerant fluid at low pressure circulates in the compressor where it is brought to high pressure, and then circulates successively in the first heat exchanger, giving up beat to the first heat transfer fluid, in the first bypass branch, in the second heat exchanger, in the second bypass branch, in the second expansion device where it undergoes expansion to an intermediate pressure, in the refrigerant fluid accumulation device, in the third bypass branch, in the third expansion device where it is brought to low pressure, in the third heat exchanger where it evaporates, absorbing heat, and returns to the compressor.

### BRIEF DESCRIPTION OF THE DRA WINGS

Further features, details and advantages will become apparent on reading the detailed description below, and on studying the appended drawings, in which:

FIG. 1 is a schematic view of a thermal conditioning system according to a first embodiment of the invention,

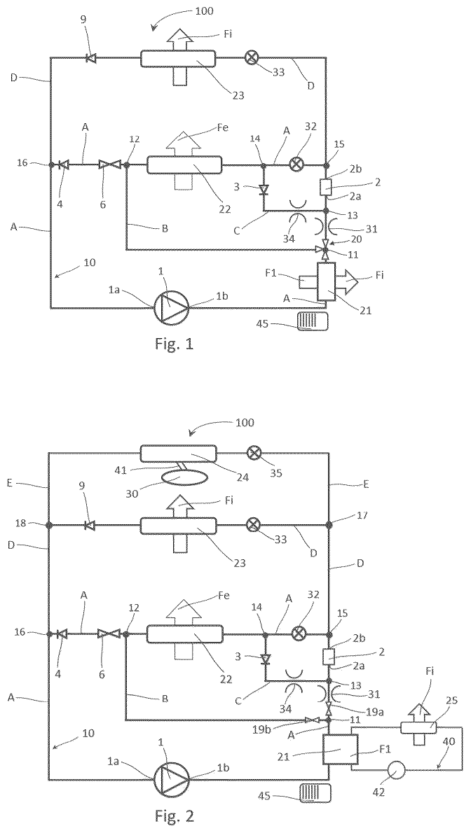

FIG. 2 is a schematic view of a thermal conditioning system according to a variant of the first embodiment of the invention,

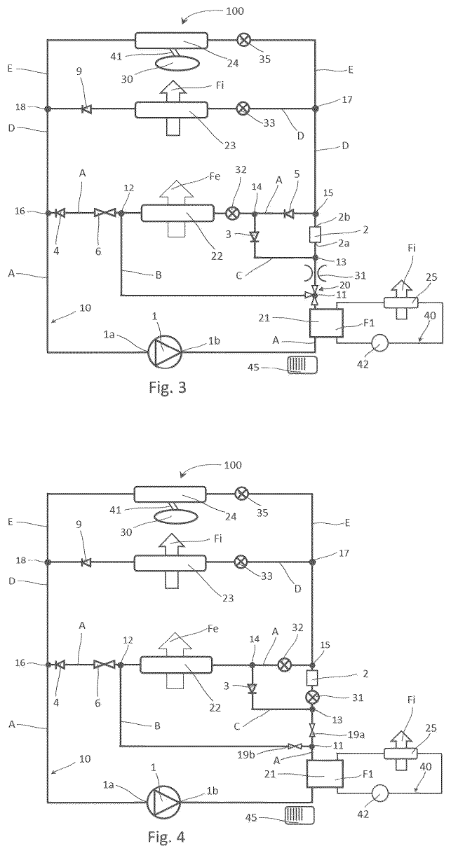

FIG. 3 is a schematic view of a thermal conditioning system according to a second embodiment of the invention,

FIG. 4 is a schematic view of a thermal conditioning system according to a third embodiment of the invention,

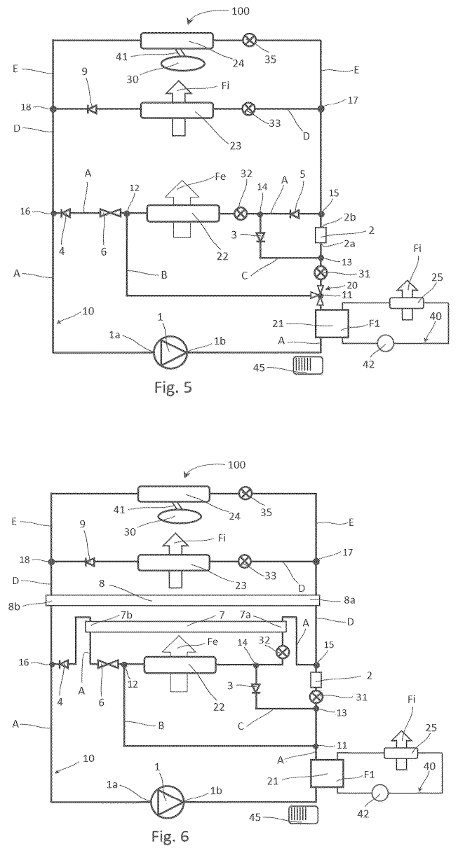

FIG. 5 is a schematic view of a thermal conditioning system according to a fourth embodiment of the invention,

FIG. 6 is a schematic view of a thermal conditioning system according to a variant of the third embodiment of the invention,

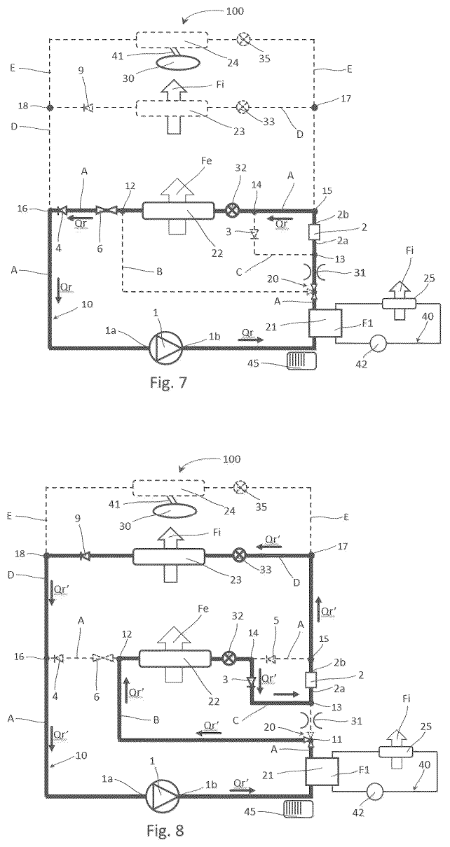

FIG. 7 is a schematic view of the thermal conditioning system according to the second embodiment, operating in a first mode of operation, referred to as heating mode,

FIG. 8 is a schematic view of the thermal conditioning system according to the second embodiment, operating in a second mode of operation, referred to as cooling mode,

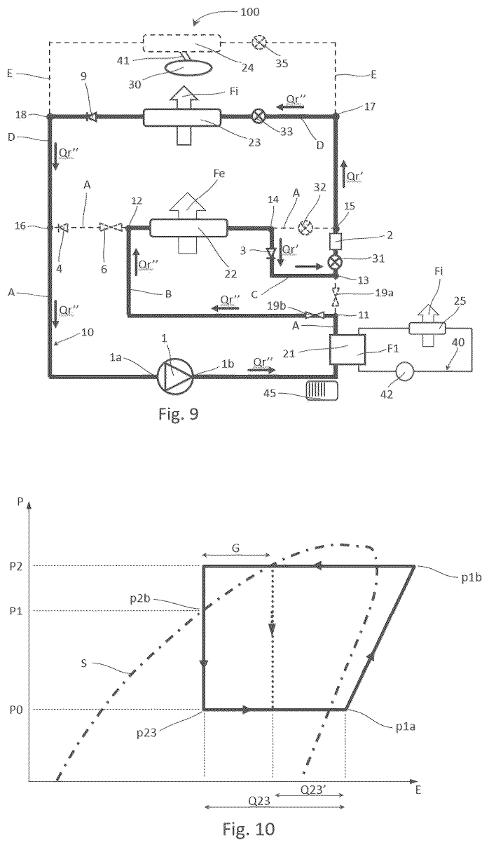

FIG. 9 is a schematic view of the thermal conditioning system according to the third embodiment, operating in a second mode of operation, referred to as cooling mode, and

FIG. 10 is a pressure and enthalpy diagram of a thermal conditioning system, in particular according to the second embodiment, operating according to the second mode of operation, referred to as cooling mode.

### DETAILED DESCRIPTION OF THE INVENTION

In order to make it easier to read the figures, the various elements are not necessarily shown to scale. In these figures, identical elements bear the same re ere me elements or parameters may be indexed, i.e. designated for example first element or second element, or first parameter and second parameter, etc. This indexing is intended to differentiate elements or parameters that are similar but not identical. This indexing does not imply priority of one element or parameter with respect to another and the designations may be interchanged.

In the following description, the expression “a first element upstream of a second element” means that the first element is placed before the second element with respect to the direction of circulation, or travel, of a fluid. Similarly, the expression “a first element downstream of a second element” means that the first element is placed after the second e with respect to the direction of circulation, or travel, of the fluid in question. In the case of the refrigerant fluid circuit, the expression “a first element is upstream of a second element” means that the refrigerant fluid travels successively through the first element and then the second element, without passing through the compression device, which is also called compressor. In other words, the refrigerant fluid leaves the compressor, possibly passes through one or more elements, and then passes through the first element, then the second element, and then returns to the compressor, possibly after having passed through other elements.

The expression “a second element is placed between a first element and a third element” means that the shortest path for traveling from the first element to the third element passes through the second element.

When it is specified that a sub-system has a given element, this does not rule out the presence of other elements in this sub-system.

An electronic control unit 45 receives information from various sensors that measure in particular the characteristics of the refrigerant fluid at various points of the circuit. The electronic control unit 45 also receives instructions issued by the occupants of the vehicle, such as for example the desired temperature inside the passenger compartment. The electronic control unit 45 may also receive instructions from other electronic sub-systems, such as for example the management system of the electrical energy storage batteries. The electronic control unit 45 implements control laws making it possible to control the various actuators, in order to control the thermal conditioning system 100 so as to carry out the instructions received.

The refrigerant fluid circuit 10 forms a closed circuit in which the refrigerant fluid can circulate. The refrigerant fluid circuit 10 is sealed when it is in a nominal operating state, i.e. without defects or leaks. Each connection point of the circuit 10 allows the refrigerant fluid to pass into one or the other of the circuit portions that meet at this connection point. The refrigerant fluid is distributed between the circuit portions that meet at a connection point by acting on the opening or the closure of the shut-off valves, non-return valves or expansion devices disposed on each of the branches. In other words, each connection point is a means for redirecting the refrigerant fluid that arrives at this connection point. Various shut-off valves and non-return valves thus make it possible to selectively direct the refrigerant fluid into the various branches of the refrigerant circuit, in order to provide various modes of operation, as will be described below.

The refrigerant fluid used by the refrigerant fluid circuit 10 is in this case a chemical fluid such as R1234yf. Other refrigerant fluids may also be used instead, such as for example R134a or R290.

Inside air stream Fi is understood to mean an air stream intended for the passenger compartment of the motor vehicle. This inside air stream Fi may circulate in a heating, ventilation and/or air-conditioning (HVAC) installation. This installation has not been shown in the various figures. A first motor-fan unit, not shown, is disposed in the heating, ventilation and/or air-conditioning installation in order to increase, as required, the flow rate of the inside air stream Fi.

Outside air stream Fe is understood to mean an air stream that is not intended for the passenger compartment of the vehicle. In other words, this air stream Fe remains outside the passenger compartment of the vehicle. A second motor-fan unit, also not shown, may be activated in order to increase, if necessary, the flow rate of the outside air stream Fe. The flow rate provided by the first motor-fan unit and by the second motor-fan unit may be adjusted in real time as a function of the heat exchange requirements, for example by the electronic control unit 45 of the thermal conditioning system 100.

The term “exchanger” is equivalent to the term “heat exchanger”, and the two terms may be used without distinction in the following description.

The present invention proposes a thermal conditioning system 100 for a motor vehicle, having a refrigerant fluid circuit 10 configured to circulate a refrigerant fluid.

The refrigerant fluid circuit 10 has:
A main loop A comprising, successively in the direction of circulation of the refrigerant fluid:
a compressor 1,
a first heat exchanger 21 configured to exchange heat with a first heat transfer fluid F1,
a refrigerant fluid accumulation device 2,
a second heat exchanger 22 configured to exchange heat with an air stream Fe outside a passenger compartment of the vehicle,
A first bypass branch B connecting a first connection point 11 disposed on the main loop A between the first exchanger 21 and the refrigerant fluid accumulation device 2 to a second connection point 12 disposed on the main loop A between the second exchanger 22 and an inlet 1a of the compressor 1,
A second bypass branch C connecting a third connection point 13 disposed on the main loop A between the first connection point 11 and the refrigerant fluid accumulation device 2 to a fourth connection point 14 disposed on the main loop A between the refrigerant fluid accumulation device 2 and the second heat exchanger 22,
A third bypass branch D connecting a fifth connection point 15 disposed on the main loop A between the refrigerant fluid accumulation device 2 and the fourth connection point 14 to a sixth connection point 16 disposed on the main loop A between the second connection point 12 and the inlet 1a of the compressor 1.

The main loop A comprises:
a first expansion device 31 disposed between the first connection point 11 and an inlet 2a of the refrigerant fluid accumulation device 2,
a second expansion device 32 disposed between the fifth connection point 15 and the second heat exchanger 22.

The third bypass branch D has a third expansion device 33 and a third heat exchanger 2 configured to operate as an evaporator.

This configuration makes it possible to realize partial expansion of the refrigerant fluid between the outlet of the first heat exchanger 21 and the inlet of the accumulation device 2. The refrigerant fluid having undergone this partial expansion thus has a enthalpy that is lower than at the outlet of the first heat exchanger 21. This difference in enthalpy makes it possible to improve the performance of the thermal conditioning system, in particular by increasing the maximum cooling power,

FIG. 1 shows a first embodiment of the thermal conditioning system 100. The first heat transfer fluid F1 is an air stream Fi inside a passenger compartment of a motor vehicle. The first heat exchanger 21 is an internal condenser and is disposed in the heating, ventilation and/or air-conditioning installation of the vehicle.

According to a variant of the first embodiment, which is illustrated in FIG. 2, the first heat transfer fluid F1 is a heat transfer liquid. The thermal conditioning system has a heat transfer liquid circuit 40 configured to circulate a heat transfer liquid. The first heat exchanger 21 is a two-fluid heat exchanger arranged jointly on the refrigerant fluid circuit 10 and on the heat transfer fluid circuit 40 so as to allow heat exchange between the refrigerant fluid and the heat transfer liquid.

The heat exchange liquid circuit 40 has a fifth heat exchanger 25 configured to exchange beat with a flow of air Fi inside a passenger compartment of the vehicle. The fifth heat exchanger 25 is disposed in the heating, ventilation and/or air-conditioning installation. The heat transfer liquid circuit 40 comprises a pump 42 for circulation of the heat transfer liquid. The pump 42 can be selectively activated and deactivated, for example by a command from the electronic control unit 45. The heat transfer liquid circuit 40 also comprises a sixth heat exchanger, not shown, configured to exchange heat with the outside air stream Fe.

In the first embodiment as in its variant, the first heat exchanger 21 is a condenser. Depending on the embodiment, the heat supplied by the condensation of the refrigerant fluid is dissipated into the inside air stream Fi, or into the heat transfer liquid of the circuit 40.

When the heat given off by the condensation of the refrigerant fluid in the first exchanger 21 is dissipated into the inside air stream Fi, the heating of the passenger compartment is said to be direct. When the heat given off by the condensation of the refrigerant fluid in the first exchanger 21 is dissipated first into the heat transfer liquid of the circuit 40, and then into the inside air stream Fi via the fifth exchanger 25, the heating of the passenger compartment is said to be indirect.

The second heat exchanger 22 is an evaporator-condenser. In other words, the second heat exchanger 22 can selectively operate either as an evaporator or as a condenser.

In the examples shown, the third heat exchanger 23 is configured to exchange heat with an air stream Fi inside the passenger compartment of the vehicle. The third heat exchanger 23 is an evaporator disposed in the heating, ventilation and/or air-conditioning installation.

The refrigerant fluid accumulation device 2 is a bottle of desiccant. The term “accumulation device” is equivalent to the term “refrigerant fluid accumulation device”.

The bottle of desiccant 2 can receive at its inlet 2a a two-phase mixture of refrigerant fluid. In the steady state, the refrigerant fluid reaching the inlet of the bottle of desiccant is in the saturated liquid state and the refrigerant fluid leaving the outlet 2b of the bottle of desiccant is in the saturated liquid state.

According to the variant of the first embodiment that is illustrated in FIG. 2, and in the other embodiments illustrated, the thermal conditioning system 100 has a fourth bypass branch B in parallel with the third expansion device 33 and the third heat exchanger 23, the fourth bypass branch E having a fifth expansion device 35 and a fourth heat exchanger 24. This fourth bypass branch E and the associated components are optional.

The fourth bypass branch E connects a seventh connection point 17 disposed on the third bypass branch D between the fifth connection point 15 and the third expansion device 33 to an eighth connection point 18 disposed on the third bypass branch D between the third heat exchanger 23 and the sixth connection point 16.

The fourth heat exchanger 24 is thermally coupled to an element 30 of a drive train of a motor vehicle. The fourth heat exchanger 24 thus makes it possible to control the operating temperature of the element 30 of the drive train of the vehicle.

The element 30 of the electric drive train of the vehicle may comprise an electrical energy storage battery. The battery may supply the energy necessary to drive the vehicle.

The element 30 of the electric drive train of the vehicle may comprise an electric drive motor of the vehicle. The element 30 of the electric drive train of the vehicle may comprise an electronic control unit for the electric drive motor of the vehicle.

The fourth heat exchanger 24 is in this case thermally coupled to the element 30 via a heat transfer liquid circulating in a secondary heat transfer liquid loop 41. The heat transfer liquid circulating in the secondary heat transfer liquid loop 41 may be a dielectric fluid. Alternatively, the heat transfer liquid circulating in the secondary heat transfer liquid loop 41 may be a mixture of water and glycol.

According to another variant embodiment, the fourth heat exchanger 24 is in contact with the element 30 of the drive train of the vehicle. A wall of the fourth heat exchanger 24 is thus in contact with a wall of the first element 25. A paste aimed at improving the heat transfer between the two walls may be disposed between these two walls.

According to the first embodiment of the thermal conditioning system 100, which is illustrated in FIG. 1, the first expansion device 31 is disposed on the main loop A between the first connection point 11 and the third connection point 13. The second expansion device 32 is disposed on the main loop A between the fifth connection point 15 and the fourth connection point 14.

The first expansion device 31 is, in this first embodiment, a calibrated orifice. A calibrated orifice is a passive component. A calibrated orifice has a constant passage section, which cannot be modified over time. The second expansion device 32 is an electronic expansion valve. In an electronic expansion valve, the passage section allowing the refrigerant fluid to pass through can be adjusted continuously between a closure position and a maximum opening position. For this purpose, the control unit 45 of the thermal conditioning system 100 can, for example, control an electric motor that moves a mobile shutter controlling the passage section available to the refrigerant fluid. The control of the position of the mobile shutter makes it possible to control the expansion. The expansion of the refrigerant fluid in the second expansion device 32 can be modified in real time.

The second bypass branch C comprises a fourth expansion device 34. The fourth expansion device 34 is in this case a calibrated orifice.

The use of calibrated orifices makes it possible to realize the first level of expansion, between the first heat exchanger 21 and the bottle of desiccant 2, through an inexpensive component.

FIG. 3 shows a second embodiment of the thermal conditioning system 100. In this embodiment, the first expansion device 31 is disposed on the main loop A between the first connection point 11 and the third connection point 13. The second expansion device 32 is disposed on the main loop A between the fourth connection point 14 and the second heat exchanger 22.

The first expansion device 31 is in this case a calibrated orifice. The second expansion device 32 is an electronic expansion valve. In this embodiment, the second bypass branch C does not have an expansion device.

FIG. 4 shows a third embodiment of the thermal conditioning system 100. In this third embodiment, the first expansion device 31 is disposed on the main loop A between the third connection point 13 and an inlet 2a of the refrigerant fluid accumulation device 2. The second expansion device 32 is disposed on the main loop A between the fifth connection point 15 and the fourth connection point 14. In this embodiment, the second bypass branch C does not have an expansion device.

The first expansion device 31 is an electronic expansion valve. The second expansion device 32 is an electronic expansion valve.

The use of electronic expansion valves makes it possible to adapt, in real time, the amplitude of the partial expansion of the refrigerant fluid to all the operating conditions encountered. The operation of the thermal conditioning system can thus be optimized.

FIG. 5 shows a fourth embodiment of the thermal conditioning system 100. According to this fourth embodiment of the thermal conditioning system 100, the first expansion device is disposed on the main loop A between the first connection point 11 and the third connection point 13. The second expansion device is disposed on the main loop A between the fourth connection point 14 and the second heat exchanger 22. In this embodiment, the second bypass branch C does not have an expansion device.

The first expansion device 31 is an electronic expansion valve. The second expansion device 32 is an electronic expansion valve.

In the four main embodiments presented and the associated variants, the second bypass branch C comprises a first non-return valve 3 configured to block circulation of refrigerant fluid from the third connection point 13 to the fourth connection point 14. The first non-return valve 3 makes it possible to prevent the refrigerant fluid at high pressure at the inlet of the accumulation device 2 from flowing back to the fourth connection point 14 by circulating in the second bypass branch C. The first non-return valve 3 is configured to allow circulation of refrigerant fluid from the fourth connection point 14 to the third connection point 13.

In the four embodiments illustrated and the associated variants, the main loop A comprises a second non-return valve 4 configured to block circulation of refrigerant fluid from the sixth connection point 16 to the second connection point 12. The second non-return valve 4 is configured to allow circulation of refrigerant fluid from the second connection point 12 to the sixth connection point 16.

According to the second and the fourth embodiments, which are illustrated respectively in FIG. 3 and FIG. 5, the main loop A comprises a third non-return valve 5 configured to block circulation of refrigerant fluid from the fourth connection point 14 to the fifth connection point 15. The third non-return valve 5 is configured to allow circulation of refrigerant fluid from the fifth connection point IS to the fourth connection point 14.

According to the embodiments illustrated, the third bypass branch D comprises a fourth non-return valve 9 configured to block circulation of refrigerant fluid from the eighth connection point 18 to the third heat exchanger 23. The fourth non-return valve 9 is configured to allow circulation of refrigerant fluid from the third heat 23 to the eighth connection point 18.

According to variants that are not shown, each non-return valve 3, 4, 5, 9 can be replaced by a shut-off valve. The one or more shut-off valves are controlled electrically, for example by the electronic control unit 45.

The main loop A comprises a shut-off valve 6 disposed between the second connection point 12 and the sixth connection point 16. The shut-off valve 6 makes it possible to selectively interrupt the circulation of refrigerant fluid in the main loop A, from the second connection point 12 to the sixth connection point 16. The refrigerant fluid circulating in the first bypass branch B then circulates from the second connection point 12 to the fourth connection point 14, passing through the second heat exchanger 22. The shut-off valve 6 is present in all the embodiments illustrated.

According to a variant of the third embodiment of the thermal conditioning system 100, which is illustrated in FIG. 6, the main loop A comprises a first internal heat exchanger 7 configured to allow heat exchange between the refrigerant fluid downstream of the first expansion device 31 and the refrigerant fluid downstream of the second heat exchanger 22.

The first internal heat exchanger 7 makes it possible to superheat the refrigerant fluid at the inlet of the compressor 1, i.e. makes it possible to avoid the presence of droplets of liquid refrigerant at the inlet of the compressor 1.

The first internal heat exchanger 7 has a first heat exchange section 7a disposed on the main loop A downstream of the fifth connection point 15 and upstream of the second expansion valve 32, and a second heat exchange section 7b disposed on the main loop A downstream of the second connection point 12. The first internal heat exchanger 7 is configured to allow heat exchange between the refrigerant fluid in the first heat exchange section 7a and the refrigerant fluid in the second heat exchange section 7b. The refrigerant fluid circulating at high pressure in the main loop A may thus give up heat to the refrigerant fluid circulating at a lower pressure in the main loop A, after having been expanded in the second expansion valve 32 and passed into the second heat exchanger 22.

In this variant, the third bypass branch D also comprises a second internal heat exchanger 8 configured to allow heat ex change between the refrigerant fluid upstream of the third expansion device 33 and the refrigerant fluid downstream of the third heat exchanger 23. The second internal heat exchanger 8 makes it possible to increase the variation in enthalpy between the inlet and the outlet of the third heat exchanger 23. The cooling performance is improved. When the fourth heat exchanger 24 is used, the second internal exchanger 8 also makes it possible to improve the performance thereof.

The second internal heat exchanger 8 has a first heat exchange section 8a disposed on the third bypass branch D upstream of the third expansion valve 33 and a second heat exchange section 8b disposed on the third bypass branch downstream of the third at exchanger 23. The second internal heat exchanger 8 is configured to allow heat exchange between the refrigerant fluid in the first heat exchange section 8a and the refrigerant fluid in the second heat exchange section 8b. The refrigerant fluid circulating at high pressure in the third bypass branch D may thus give up heat to the refrigerant fluid circulating at a lower pressure in e bypass branch D, after expansion in the third expansion valve 33.

The two internal heat exchangers 7, 8 can be added to the thermal conditioning system according to the first, second and third embodiments.

According to variants that are not shown, the thermal conditioning system 100 comprises a single internal heat exchanger. The single internal heat exchanger may be the first internal heat exchanger 7 or the second internal heat exchanger 8.

Depending on the embodiments, the refrigerant fluid coming from the first beat exchanger 21 and reaching the first connection point 11 can be directed toward the first bypass branch B, or continue to circulate in the main loop A. For this purpose, various types of valves can be used.

The thermal conditioning system 100 may have a three-way valve 20 disposed jointly on the main loop A and the first bypass branch B. The three-way valve 20 is configured to selectively:
allow circulation of the refrigerant fluid at the outlet of the first exchanger 21 to the third connection point 13 and prevent circulation of the refrigerant fluid at the outlet of the first exchanger 21 to the second connection point 12, or
allow circulation of the refrigerant fluid at the outlet of the first exchanger 21 to the second connection point 12 and prevent circulation of the refrigerant fluid 21 at the outlet of the first exchanger to the third connection point 13.

The three-way valve 20 is present in the first, second and fourth embodiments, which are illustrated respectively in FIGS. 1, 3 and 5. According to one implementation example, the three-way valve 20 and the first expansion device 31 form a one-piece assembly. The integration into the thermal conditioning system is thus made easier.

Instead of the three-way valve 20, the thermal conditioning system 100 may have two two-way valves 19a, 19b. A first two-way valve 19a is disposed on the main loop A between the first connection point 11 and the third connection point 13. A second two-way valve 19b is disposed on the first bypass branch B second two-way valve 196 is disposed between the first connection point 11 and the second connection point 12. Each two-way valve 19a, 19b is controlled electrically. Each two-way valve 19a, 19b makes it possible to selectively allow fluidic communication between its inlet and its outlet, or prevent fluidic communication between its inlet and its outlet. Each two-way valve 19a, 19b is a valve for shutting off the circulation of refrigerant fluid. The combination of the two shut-off valves 19a, 19b is present in the variant of the first embodiment and in the third embodiment, which are illustrated respectively in FIG. 2 and FIG. 4.

A number of possible modes of operation of the thermal conditioning system 100 will now be described.

FIG. 7 shows a method of operation of a thermal conditioning system 100 according to the second embodiment, in a mode referred to as heating mode, wherein:
a flow Qr of refrigerant fluid at low pressure circulates in the compressor 1 where it is brought to high pressure, and then circulates successively in the first heat exchanger 21, giving up heat to the first heat transfer fluid F1, in the first expansion device 31 where it undergoes expansion to an intermediate pressure, in the second heat exchanger 22, in the refrigerant fluid accumulation device 2, in the second expansion device 32 where it is brought to low pressure, in the second heat e hanger 22 where it evaporates, absorbing heat from the outside air stream Fe, and returns to the compressor 1.

When the thermal conditioning system 100 operates according to this mode of operation, the second heat exchanger 22 is traveled through in a first direction of travel. This mode of operation has been represented on the basis of the second embodiment, and is applicable to all the embodiments.

In this heating mode, the heat from of the outside air stream Fe contributes to heating the passenger compartment of the vehicle. The intermediate expansion realized by the first expansion device 31 makes it possible to increase the quantity of heat extracted from the outside air stream Fe.

FIG. 8 shows a method of operation of a thermal conditioning system 100 according to the second embodiment, in a mode referred to as cooling mode, wherein:
a flow Qr′ of refrigerant fluid at low pressure circulates in the compressor 1 where it is brought to high pressure, and then circulates successively in the first heat exchanger 21, giving up beat to the first heat transfer fluid F1, in the first bypass branch B, in the second heat exchanger 22, in the second expansion device 32 where it undergoes expansion to an intermediate pressure, in the second bypass branch C, in the refrigerant fluid accumulation device 2, in the third bypass branch D, in the third expansion device 33 where it is brought to low pressure, in the third heat exchanger 23 where it evaporates, absorbing heat, and returns to the compressor 1.

When the thermal conditioning system 100 operates according to the mode of operation referred to as cooling mode, the second heat exchanger 22 is traveled through in a direction of travel that is opposite the first direction of travel followed in heating mode. The refrigerant fluid undergoes a first level of expansion between the outlet of the first exchanger 21 and the inlet of the accumulation device both during the operation in heating mode and during the operation in cooling mode. All the embodiments make it possible to obtain partial expansion of the refrigerant fluid downstream of the first heat exchanger 21 and upstream of the refrigerant fluid accumulation device 2.

The three-way valve 11 directs the flow Qr′ of refrigerant fluid coming from the first heat exchanger 21 toward the first bypass branch B. The refrigerant fluid does not circulate between the first connection point 11 and the third connection point 13. At the second connection point 12, the refrigerant fluid joins the main loop A and circulates in the second heat exchanger 22. The shut-off valve 6 is in the closed position and prevents the refrigerant fluid from circulating to the sixth connection point 16. The refrigerant fluid having exchanged heat with the outside air stream Fe at the second exchanger 22 undergoes intermediate expansion, passing through the second expansion valve 32. At the fourth connection point 14, the third non-return valve 5 prevents the refrigerant fluid from circulating to the fifth connection point 15. The refrigerant fluid circulates in the second bypass branch C, joins the main loop A at the third connection point 13 and passes through the accumulation device 2. The refrigerant fluid circulates in the third bypass branch D and reaches the third expansion device 33 where it undergoes expansion bringing it from the intermediate pressure to a low-pressure state. The refrigerant fluid evaporates in the third exchanger 23, joins the main loop A at the sixth connection point 16, and reaches the inlet 1a of the compressor 1, and this completes the thermodynamic cycle.

FIG. 10 illustrates this method of operation through a pressure and enthalpy diagram. The point p1a represents the state of the refrigerant fluid at low pressure P0 at the inlet of the compressor 1. The point p1b represents the state of the refrigerant fluid at high pressure P2 and high temperature at the outlet of the compressor 1. The point p2b represents the state of the refrigerant fluid at the outlet of the bottle of desiccant 2. The point p2b is on the characteristic saturation curve S of the refrigerant fluid used, for the intermediate pressure P1. The point p23 corresponds to the state of the refrigerant fluid at the inlet of the third heat exchanger 23. The arrow Q23 represents the variation in enthalpy of the refrigerant fluid during its evaporation in the third exchanger 23. The power for cooling the inside air stream Fi is proportional to the quantity schematically shown by Q23. The arrow Q23′ represents the variation in enthalpy of the refrigerant fluid for a conditioning system that does not make it possible to realize intermediate expansion between the outlet of the first exchanger 21 and the bottle 2. In such a system, the enthalpy of the refrigerant fluid at the outlet of the bottle 2 corresponds to the saturation point at the pressure P2. The dotted arrow schematically shows the phase of expansion through the third expansion valve 33. In such a case, the variation in enthalpy is less than in the thermal conditioning system proposed here. The available cooling power is also lower. The arrow G schematically shows the improvement obtained in the tion in enthalpy by virtue of the intermediate expansion realized by the proposed thermal conditioning system.

FIG. 9 shows a method of operation of a thermal conditioning system 100 according to the third embodiment, in a mode referred to as cooling mode, wherein:
a flow Qr″ of refrigerant fluid at low pressure circulates in the compressor 1 where it is brought to high pressure, and then circulates successively in the first heat exchanger 21, giving up heat to the first heat transfer fluid F1, in the first bypass branch B, in the second heat exchanger 22, in the second bypass branch C, in the second expansion device 32 where it undergoes expansion to an intermediate pressure, in the refrigerant fluid accumulation device 2, in the third bypass branch D, in the third expansion device 33 where it is brought to low pressure, in the third heat exchanger 23 where it evaporates, absorbing heat, and returns to the compressor 1.

The second two-way valve 19b is open while the first two-way valve 19a is closed. At the first connection point 11, the refrigerant fluid leaving the compressor 1 at high pressure and high temperature circulates in the first bypass branch B. The shut-off valve 6 is closed, such that at the second connection point 12 the refrigerant fluid is redirected toward the main loop A and condenses at the second exchanger 22 by dissipating heat into the outside air stream Fe. The second expansion valve 32 is in the closed position, such that the refrigerant fluid that has exchanged heat in the second heat exchanger 22 takes, at the fourth connection point 14, the second bypass branch C. The first expansion device 31 realizes partial expansion of the refrigerant fluid before the latter enters the bottle 2. The third expansion device 33 expands the refrigerant fluid to a low pressure, and evaporation of the refrigerant fluid at the third exchanger 23 cools the inside air stream Fi. The refrigerant fluid at low pressure reaches the inlet 1a of the compressor 1. At the sixth connection point 16, the second non-return valve 4 prevents the refrigerant fluid from circulating to the second connection point 12.

Numerous other modes of operation, which are not shown, are also possible. For example, it is possible to cause a flow of refrigerant fluid to pass in parallel into the third exchanger 3 and into the fourth exchanger 4 so as to jointly cool the inside air stream Fi and the element 30 of the drive train of the vehicle. The respective degree of opening of the third expansion valve 33 and of the fifth expansion valve 35 makes it possible to distribute the cooling power between these two heat exchangers.

What is claimed is:

1. A thermal conditioning system for a motor vehicle, comprising a refrigerant fluid circuit configured to circulate a refrigerant fluid, the refrigerant fluid circuit having:
a main loop including, successively in the direction of circulation of the refrigerant fluid:
compressor,
a first heat exchanger configured to exchange heat with a first heat transfer fluid,
a refrigerant fluid accumulation device,
a second heat exchanger configured to exchange heat with an air stream outside a passenger compartment of the vehicle;
a first bypass branch connecting a first connection point disposed on the main loop between the first exchanger and the refrigerant fluid accumulation device to a second connection point disposed on the main loop between the second exchanger and an inlet of the compressor,
a second bypass branch connecting a third connection point disposed on the main loop between the first connection point and the refrigerant fluid accumulation device to a fourth connection point disposed on the main loop between the refrigerant fluid accumulation device and the second heat exchanger,
a third bypass branch connecting a fifth connection point disposed on the main loop between the refrigerant fluid accumulation device and the fourth connection point to a sixth connection point disposed on the main loop between the second connection point and the inlet of the compressor,
wherein the main loop includes:
a first expansion device disposed between the first connection point and an inlet of the refrigerant fluid accumulation device,
a second expansion device disposed between the fifth connection point and the second heat exchanger,
and wherein the third bypass branch has a third expansion device and a third heat exchanger configured to operate as an evaporator.

2. The thermal conditioning system as claimed in claim 1, wherein the first heat transfer fluid is a heat transfer liquid, the thermal conditioning system further comprising a heat transfer liquid circuit configured to circulate a heat transfer liquid, and wherein the first heat exchanger is a two-fluid heat exchanger arranged jointly on the refrigerant fluid circuit and on the heat transfer fluid circuit so as to allow heat exchange between the refrigerant fluid and the heat transfer liquid.

3. The thermal conditioning system as claimed in claim 1, wherein the first expansion device is a calibrated orifice disposed on the main loop between the first connection point and the third connection point, wherein the second expansion device is an electronic expansion valve disposed on the main loop between the fifth connection point and the fourth connection point, and wherein the second bypass branch includes a fourth expansion device.

4. The thermal conditioning system as claimed in claim 1, wherein the first expansion device is a calibrated orifice disposed on the main loop between the first connection point and the third connection point, and wherein the second expansion device is an electronic expansion valve disposed on the main loop between the fourth connection point and the second heat exchanger.

5. The thermal conditioning system as claimed in claim 1, wherein the first expansion device is an electronic expansion valve disposed on the main loop between the third connection point and an inlet of the refrigerant fluid accumulation device, and wherein the second expansion device is an electronic expansion valve disposed on the main loop between the fifth connection point and the fourth connection point.

6. The thermal conditioning system as claimed in claim 1, wherein the second bypass branch comprises a first non-return valve configured to block circulation of refrigerant fluid from the third connection point to the fourth connection point.

7. The thermal conditioning system as claimed in claim 1, wherein the main loop comprises a second non-return valve configured to block circulation of refrigerant fluid from the sixth connection point to the second connection point, and/or a third non-return valve configured to block circulation of refrigerant fluid from the fourth connection point to the fifth connection point.

8. The thermal conditioning system as claimed in claim 1, wherein the third bypass branch comprises a fourth non-return valve configured to block circulation of refrigerant fluid from the eighth connection point to the third heat exchanger.

9. The thermal conditioning system as claimed in claim 1, wherein the first expansion device is an electronic expansion valve disposed on the main loop between the first connection point and the third connection point, and wherein the second expansion device is an electronic expansion valve disposed on the main loop between the fourth connection point and the second heat exchanger.

10. The thermal conditioning system as claimed in claim 1, wherein the main loop comprises a first internal heat exchanger configured to allow heat exchange between the refrigerant fluid downstream of the first expansion device and the refrigerant fluid downstream of the second heat exchanger, and wherein the third bypass branch comprises a second internal heat exchanger configured to allow heat exchange between the refrigerant fluid upstream of the third expansion device and the refrigerant fluid downstream of the third heat exchanger.

11. The thermal conditioning system as claimed in claim 1, having a fourth bypass branch in parallel with the third expansion device and the third heat exchanger, the fourth bypass branch having a fifth expansion device and a fourth heat exchanger, wherein the fourth heat exchanger is thermally coupled to an element of a drive train of a motor vehicle.

12. The thermal conditioning system as claimed in claim 1, having a three-way valve disposed jointly on the main loop and the first bypass branch, the three-way valve being configured to selectively:
allow circulation of the refrigerant fluid at the outlet of the first exchanger to the third connection point and prevent circulation of the refrigerant fluid at the outlet of the first exchanger to the second connection point, or
allow circulation of the refrigerant fluid at the outlet of the first exchanger to the second connection point and prevent circulation of the refrigerant fluid at the outlet of the first exchanger to the third connection point,
wherein the three-way valve and the first expansion device form a one-piece assembly.

13. A method of operation of a thermal conditioning system for a motor vehicle, including a refrigerant fluid circuit configured to circulate a refrigerant fluid, the refrigerant fluid circuit having:
a main loop including, successively in the direction of circulation of the refrigerant fluid:
a compressor,
a first heat exchanger configured to exchange heat with a first heat transfer fluid,
a refrigerant fluid accumulation device,
a second heat exchanger configured to exchange heat with an air stream outside a passenger compartment of the vehicle;
a first bypass branch connecting a first connection point disposed on the main loop between the first exchanger and the refrigerant fluid accumulation device to a second connection point disposed on the main loop between the second exchanger and an inlet of the compressor,
a second bypass branch connecting a third connection point disposed on the main loop between the first connection point and the refrigerant fluid accumulation device to a fourth connection point disposed on the main loop between the refrigerant fluid accumulation device and the second heat exchanger,
a third bypass branch connecting a fifth connection point disposed on the main loop between the refrigerant fluid accumulation device and the fourth connection point to a sixth connection point disposed on the main loop between the second connection point and the inlet of the compressor,
wherein the main loop includes:
a first expansion device disposed between the first connection point and an inlet of the refrigerant fluid accumulation device,
a second expansion device disposed between the fifth connection point and the second heat exchanger,
and wherein the third bypass branch has a third expansion device and a third heat exchanger configured to operate as an evaporator, in a mode referred to as heating mode, wherein the method comprises:
circulating a flow of refrigerant fluid at low pressure in the compressor where it is brought to high pressure, and then circulating the flow successively in the first heat exchanger, giving up heat to the first heat transfer fluid, in the first expansion device where it undergoes expansion to an intermediate pressure, in the second heat exchanger, in the refrigerant fluid accumulation device, in the second expansion device where it is brought to low pressure, in the second heat exchanger where it evaporates, absorbing heat from the outside air stream, and returns to the compressor.

14. A method of operation of a thermal conditioning system as for a motor vehicle, including a referent fluid circuit configured to circulate a refrigerant fluid, the refrigerant fluid circuit having:
a main loop including, successively in the direction of circulation of the refrigerant fluid:
compressor,
a first heat exchanger configured to exchange heat with a first heat transfer fluid,
a refrigerant fluid accumulation device,
a second heat exchanger configured to exchange heat with an air stream outside a passenger compartment of the vehicle;
a first bypass branch connecting a first connection point disposed on the main loop between the first exchanger and the refrigerant fluid accumulation device to a second connection point disposed on the main loop between the second exchanger and an inlet of the compressor,
a second bypass branch connecting a third connection point disposed on the main loop between the first connection point and the refrigerant fluid accumulation device to a fourth connection point disposed on the main loop between the refrigerant fluid accumulation device and the second heat exchanger,
a third bypass branch connecting a fifth connection point disposed on the main loop between the refrigerant fluid accumulation device and the fourth connection point to a sixth connection point disposed on the main loop between the second connection point and the inlet of the compressor,
wherein the main loop includes:
a first expansion device disposed between the first connection point and an inlet of the refrigerant fluid accumulation device,
a second expansion device disposed between the fifth connection point and the second heat exchanger,
and wherein the third bypass branch has a third expansion device and a third heat exchanger configured to operate as an evaporator, wherein the main loop comprises a second non-return valve configured to block circulation of refrigerant fluid from the sixth connection point to the second connection point, and/or a third non-return valve configured to block circulation of refrigerant fluid from the fourth connection point to the fifth connection point, in a mode referred to as cooling mode, wherein:
circulating a flow of refrigerant fluid at low pressure in the compressor where it is brought to high pressure, and then circulating successively in the first heat exchanger, giving up heat to the first heat transfer fluid, in the first bypass branch, in the second heat exchanger, in the second expansion device where it undergoes expansion to an intermediate pressure, in the second bypass branch, in the refrigerant fluid accumulation device, in the third bypass branch, in the third expansion device where it is brought to low pressure, in the third heat exchanger where it evaporates, absorbing heat, and returns to the compressor.

15. A method of operation of a thermal conditioning system for a motor vehicle, including a refrigerant fluid circuit configured to circulate fluid, the refrigerant fluid circuit having:
a main loop including, successively in the direction of circulation of the refrigerant fluid:
a compressor,
a first heat exchanger configured to exchange heat with a first heat transfer fluid,
a refrigerant fluid accumulation device,
a second heat exchanger configured to exchange heat with an air stream outside a passenger compartment of the vehicle;
a first bypass branch connecting a first connection point disposed on the main loop between the first exchanger and the refrigerant fluid accumulation device to a second connection point disposed on the main loop between the second exchanger and an inlet of the compressor,
a second bypass branch connecting a third connection point disposed on the main loop between the first connection point and the refrigerant fluid accumulation device to a fourth connection point disposed on the main loop between the refrigerant fluid accumulation device and the second heat exchanger,
a third bypass branch connecting a fifth connection point disposed on the main loop between the refrigerant fluid accumulation device and the fourth connection point to a sixth connection point disposed on the main loop between the second connection point and the inlet of the compressor,
wherein the main loop includes:
a first expansion device disposed between the first connection point and an inlet of the refrigerant fluid accumulation device,
a second expansion device disposed between the fifth connection point and the second heat exchanger,
and wherein the third bypass branch has a third expansion device and a third heat exchanger configured to operate as an evaporator, in a mode referred to as cooling mode, wherein:
circulating a flow of refrigerant fluid at low pressure in the compressor where it is brought to high pressure, and then circulating successively in the first heat exchanger, giving up heat to the first heat transfer fluid, in the first bypass branch, in the second heat exchanger, in the second bypass branch, in the second expansion device where it is undergoes expansion to an intermediate pressure, in the refrigerant fluid accumulation device, in the third bypass branch, in the third expansion device where it is brought to low pressure, in the third head exchanger where it evaporates, absorbing heat, and returns to the compressor.
